(19) United States
(12) Patent Application Publication
(10) Pub. No.: US 2014/0116988 A1
(43) Pub. Date: May 1, 2014

(54) MELT CUTTER

(71) Applicant: Yuan-Hung WEN, Hemei Town (TW)

(72) Inventor: Yuan-Hung WEN, Hemei Town (TW)

(21) Appl. No.: 13/663,402

(22) Filed: Oct. 29, 2012

(51) Int. Cl. B23K 28/00

(52) U.S. Cl. 219/68

(57) ABSTRACT

A melt cutter includes a case, an electricity-connecting portion, a heating device, a working portion, a controlling portion, and a heat-dissipating device. The case has a heat-dissipating zone. The electricity-connecting portion is disposed in the case for connecting with an electricity source. The working portion is disposed in the case and has a gap with changeable size for clamping an object. The controlling portion alternatively triggers the heating device to heat and to transmit heat to the working portion, and it also reduces the size of the gap for melting and cutting the object. The heat-dissipating device is disposed at the heat-dissipating zone and is electrically connected with the electricity-connecting portion. Thereby, the heat-dissipating device helps air communication between interior and exterior of the case.

### BACKGROUND OF THE INVENTION

1. Field of the Invention

The present invention relates to a melt cutter, more specifically to a melt cutter having heat-dissipating device.

2. Description of the Prior Art

Conventionally, a metal wire is cut by cutter with high hardness. However, the metal wire also has a quite high hardness, so cutting operation may be very dangerous and difficult.

A melt cutter to solve the previous problems is disclosed in patent TW M425753 by the inventor of the present invention. The metal wire is simultaneously melted during cutting to reduce time of operating. To prevent the heater from overheated, the melt cutter is usually disposed with automatic electricity-cutting mechanism. However, when the electricity is cut, re-heating to the working temperature may be time-consuming, and efficiency is reduced.

### SUMMARY OF THE INVENTION

The main object of the present invention is to provide a melt cutter to improve heat-dissipation.

To achieve the above and other objects, a melt cutter of the present invention includes a case, an electricity-connecting portion, a heating device, a working portion, a controlling portion, and a heat-dissipating device.

The case has heat-dissipating zone, and the heat-dissipating zone forms at least one opening The case further forms a plurality of holes for facilitating air communication between interior and exterior of the case.

The electricity-connecting portion is disposed at an end of the case for connecting with an electricity source to provide electricity to the heating device and the heat-dissipating device.

The heating device is disposed in the case and is electrically connected with the electricity-connecting portion. The heating device further has a micro-switch.

The working portion is disposed in the case and includes an upper working piece and a lower working piece. A gap is defined between the upper and the lower working pieces for clamping an object.

The controlling portion alternatively triggers the heating device to heat and transmit heat to the working portion, and the controlling portion also triggers the upper and the lower working pieces to approach each other so as to reduce the gap to melt and cut the object off.

The heat-dissipating device is disposed at the heat-dissipating zone of the case and is electrically connected with the electricity-connecting portion. The heat-dissipating device is connected with the micro-switch and includes a fan. When the micro-switch is triggered by the controlling portion, the fan is also triggered to rotate.

Thereby, the melt cutter of the present invention has an improved performance of heat-dissipation due to the heat-dissipating device which facilitates air communication between the interior and the exterior of the case. Thus, a user may not feel uncomfortable due to heat during operating.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 2A is a partial enlargement drawing showing a heat-dissipating device of the present invention;

FIG. 3 is a profile of the present invention.

### DETAILED DESCRIPTION OF THE PREFERRED EMBODIMENTS

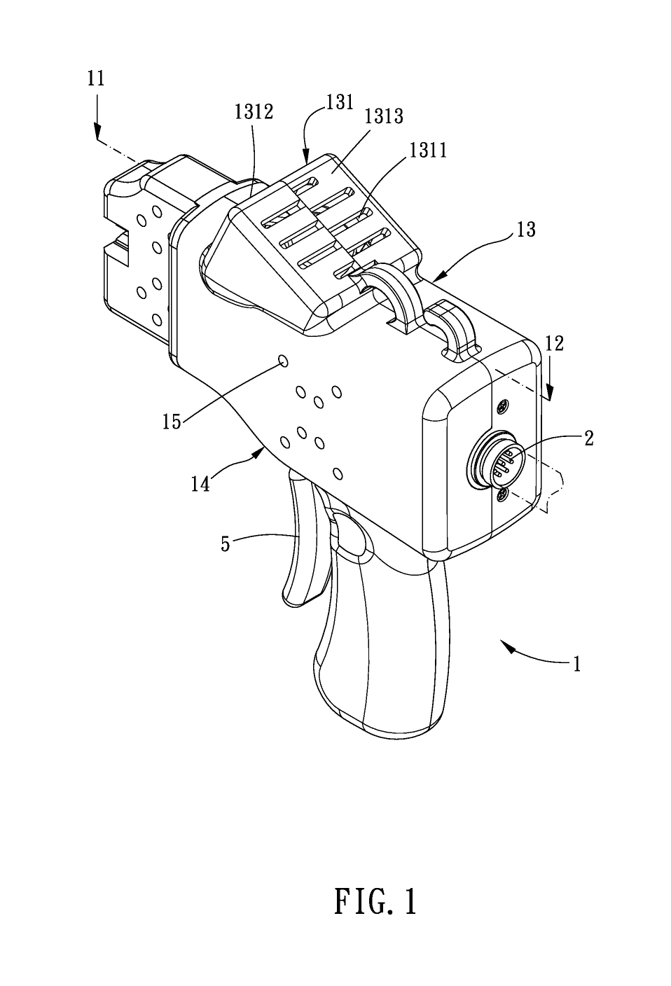

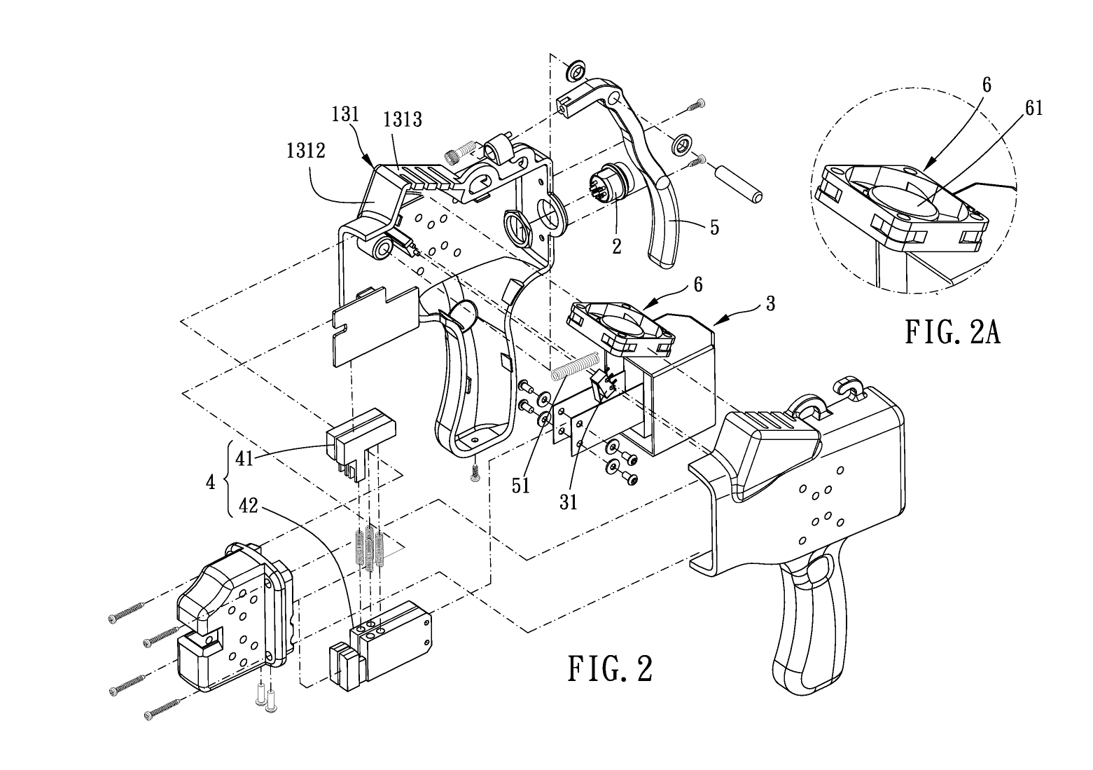

Please refer to FIG. 1 and FIG. 2. The melt cutter of the present invention includes a case 1, an electricity-connecting portion 2, a heating device 3, a working portion 4, a controlling portion 5, and a heat-dissipating device 6.

The case 1 has a first end 11 and an opposite second end 12 and also has a top portion 13 and a bottom portion 14. A heat-dissipating zone 131 is protrodingly formed above the top portion 13, and the heat-dissipating zone 131 forms at least one opening 1311 and has a first face 1312 and a second face 1313 perpendicular to the first face 1312. The opening 1311 is located on the second face 1313. Preferably, a receiving room is formed between the first face 1312 and the second face 1313. A line is defined by the first end 11 and the second end 12. An acute angle between the line and the first face 1312 is larger than an acute angle between the line and the second face 1313. The second face 1313 substantially faces to the second end 12. On the other hand, the case 1 is made of highly heat-resistant material. Also, the case 1 further has a plurality of holes 15 facilitating air communication between interior and exterior of the case 1.

The electricity-connecting portion 2 is disposed at the second end 12 of the case 1. More preferably, the electricity-connecting portion 2 is partially received in the case 1 and partially extends out of the case 1 for connecting with an electricity source. The electricity-connecting portion 2 further provides electricity to the heating device 3 and the heat-dissipating device 6.

The heating device 2 is disposed in the case 1 near the second end 12. The heating device 3 is electrically connected with the electricity-connecting portion 2. Practically, a high-frequency heater or other types of heaters can be employed as the heating device 3. Besides, the heating device 3 has a micro-switch 31.

The working portion 4 is disposed in the case 1 and is located at the first end 11. The heat-dissipating zone 131 is located between the working portion 4 and the heating device 3. The working portion 4 includes an upper working piece 41 and a lower working piece 42 which are both connected with the heating device 3. A gap is formed between the upper and the lower working pieces 41,42 for clamping an object to be cut, such as a metal wire. The following paragraphs are recited about an example for cutting a metal wire. Besides, the working portion 4 further includes at least one elastic element between the upper working piece and the lower working piece abutting thereagainst so that the upper and the lower working pieces have a tendency to move away from each other to form the gap.

The controlling portion 5 and the heat-dissipating zone 131 are located at two opposite ends of the case 1. Preferably, the controlling portion 5 is located at the bottom portion 14 of the case 1 and is connected with the micro-switch 31. The controlling portion 5 is able to alternatively trigger the micro-switch 31 for further triggering the heating device 3 to heat and to conduct heat to the working portion 4 (the upper working piece 41 and the lower working piece 42). The controlling portion 5 has an elastic element 51 connected the controlling portion 5 and the case 1 so that the controlling portion 5 tends to stay at a predetermined position. An end of the controlling portion 5 alternatively pushes the upper working piece 41 so that the upper working piece 41 and the lower working piece 42 approach each other to reduce the gap for melting and cutting the object.

The heat-dissipating device 6 is disposed at the heat-dissipating zone 131 of the case 1 and is electrically connected with the electricity-connecting portion 2. The heat-dissipating device 6 is able to facilitate air communication between interior and exterior of the case 1. Practically, the heat-dissipating device 6 includes a fan 61, as shown in FIG. 2A, which is received in a receiving room between the first face 1312 and the second face 1313. The fan 61 substantially faces toward the second face 1313. The fan 61 is able to blow toward the working portion 4 and the heating device 3 to cool them down. Of course, the fan 61 can be reversely disposed to facilitate heat inside the case 1 to be drawn out via the openings 1311 on the second face 1313. More specifically, the heat-dissipating device 6 is connected with the micro-switch 31. When the micro-switch 31 is triggered by the controlling portion 5, the fan 61 is simultaneously triggered to rotate. Also, another switch is optionally disposed on the case for launching or shutting down the heat-dissipating device.

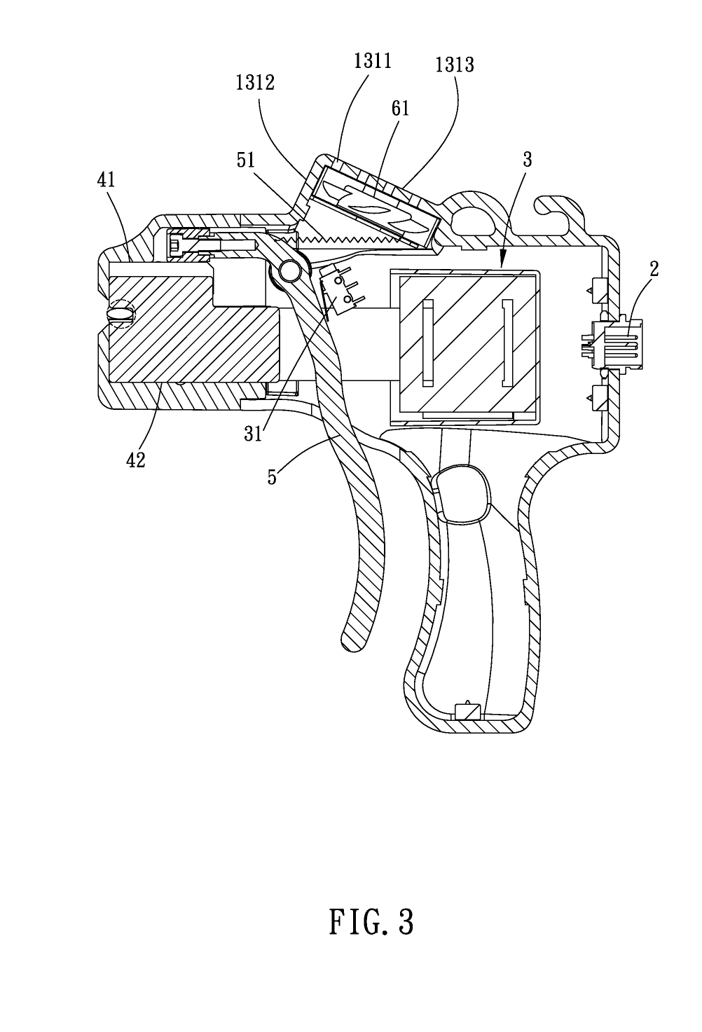

In practice, as shown in FIG. 3, when the controlling portion 5 is at an original state, the controlling portion 5 is kept at a predetermined position due to the elastic element 51 and doesn't push the upper working piece 41, and the micro-switch 31 is not triggered. When using, the object to be cut is placed at the gap between the upper and the lower working pieces 41,42. When the controlling portion 5 is exerted with force, the micro-switch 31 is triggered by the controlling portion 5 to heat and conduct heat to the upper and the lower working pieces 41,42. Also, the micro-switch 31 triggers the fan 61 to rotate so as to cool down the working portion or the heating device 3 or to draw hot air inside out via the openings 1311. At the same time, the upper working piece 41 is pushed to approach the lower working piece 42 by the controlling portion 5, and the object is melted and cut by the upper and the lower working pieces 41,42. When cutting is completed, the controlling portion 5 can be released by a user, and the controlling portion 5 moves back to the predetermined position. Thus, the micro-switch 31 is not triggered, and the heating device 3 stops heating. Also, the upper working piece 41 moves away from the lower working piece 42 to form the gap again.

In conclusion, the heat-dissipating device is able to dissipate heat from the heating device, the heat-conducting path, and the working portion. Also, hot air always moves upward, so the heat-dissipating device disposed at the top portion effectively facilitates hot air to be discharged. Moreover, the holes on the case helps bring fresh cool air outside into the case for further cooling.

In addition, the case is also cooled down to prevent user from feeling uncomfortable due to heat. Furthermore, the heat-dissipating device and the controlling portion are disposed at two opposite ends of the case, so hands of user may not be burned by hot air discharged out.

More importantly, the fan of the heat-dissipating device faces toward the second face, and the angle of the first face is larger than the angle of the second face. Thus, the second face substantially faces to the second end so that the discharged hot air may not be dissipated toward the first end, so the working portion at the first end may not be overheated.

What is claimed is:

1. A melt cutter, including:
a case, having a heat-dissipating zone;
an electricity-connecting portion, disposed in the case, being adapted for connecting with an electricity source;
a heating device, disposed in the case, being electrically connected with the electricity-connecting portion;
a working portion, disposed in the case, including an upper working piece and a lower working piece, a gap being formed between the upper and lower working pieces for clamping an object to be cut;
a control portion, alternatively triggering the heating device to heat and to transmit heat to the working portion so as to drive the upper and the lower working pieces to approach each other to reduce the gap, thereby the object to be cut being melted and cut;
a heat-dissipating device, disposed in the heat-dissipating zone of the case, the heat-dissipating device being electrically connected with the electricity-connecting portion and facilitating air communication between interior of the case and outside of the case.

2. The melt cutter of claim 1, wherein the heat-dissipating zone has at least one opening.

3. The melt cutter of claim 1, wherein the heating device further has a micro-switch, the controlling portion is able to alternatively trigger the micro-switch to further trigger the heating device to heat.

4. The melt cutter of claim 3, wherein the micro-switch is connected with the heat-dissipating device, the heat-dissipating device includes a fan, the fan is driven to rotate when the micro-switch is triggered by the controlling portion.

5. The melt cutter of claim 1, wherein the case forms a plurality of holes for facilitating air communication between the interior of the case and the outside of the case.

6. The melt cutter of claim 1, wherein the case has a first end and a second end, the case also has a top portion and a bottom portion, the working portion is located at the first end, the heating device is located near the second end, the heat-dissipating zone is protruded above the top portion of the case and is located between the working portion and the heating device, the controlling portion is located at the bottom portion of the case.

7. The melt cutter of claim 6, wherein the heat-dissipating zone forms at least one opening, the heat-dissipating zone has a first face and a second face which is perpendicular to the first face, the heat-dissipating device includes a fan, a receiving room is enclosed and defined by the first face and the second face therebetween for receiving the fan, the opening is formed on the second face, the fan faces toward the second face.

8. The melt cutter of claim 7, wherein a line is defined by the first end and the second end, an acute angle between the line and the first face is larger than an acute angle between the line and the second face.
